(19) United States
(12) Patent Application Publication
(10) Pub. No.: US 2016/0142524 A1
(43) Pub. Date: May 19, 2016

(54) MEDIA DEVICE HARNESS

(71) Applicant: Tommie Daniels, Houston, TX (US)

(72) Inventor: Tommie Daniels, Houston, TX (US)

(21) Appl. No.: 14/946,585

(22) Filed: Nov. 19, 2015

Related U.S. Application Data
(60) Provisional application No. 62/081,951, filed on Nov. 19, 2014.

(51) Int. Cl. H04M 1/05; A45F 5/00; A45C 11/00

(52) U.S. Cl. CPC H04M 1/05; A45C 11/00; A45F 5/00; A45C 2011/002; A45C 2011/003

(57) ABSTRACT

A media device harness is configured to support a media device while a user is engaged in exercise. The media device harness has a shoulder harness assembly that is configured to fit around at least one shoulder of a human user. A hip harness assembly is connected to the shoulder harness assembly and configured to hold the media device. A headphone clip assembly is configured to hold head phone wires of media device.

### RELATED APPLICATION

This application claims priority to provisional patent application U.S. Ser. No. 62/081,951 filed on Nov. 19, 2014, the entire contents of which is herein incorporated by reference.

### BACKGROUND

The embodiments herein relate generally to devices for transporting media devices. As used in this application a “media device” refers to a large smart phone, small tablet or phablet. Prior to embodiments of the disclosed invention, of comfortably carrying a media device on one's person while engaged in physical activities hands free was not possible. Embodiments of the disclosed invention solve this problem.

### SUMMARY

A media device harness is configured to support a media device while a user is engaged in physical or sports activities. The media device harness has a shoulder harness assembly that is configured to fit around at least one shoulder of a human user. A hip harness assembly is connected to the shoulder harness assembly and configured to hold the media device. A headphone clip assembly is configured to hold head phone wires of media device.

In some embodiments, the shoulder harness assembly has a shoulder pad, perforated with a plurality of shoulder pad holes at a first end and a second end. The first end is further attached to a first connector bar, a first front button and a first rear button. The second end is further attached to a second connector bar, a second front button and a second rear button.

In some embodiments, the hip harness assembly further includes a hip pad further comprising a first hip pad hole, a second hip pad hole, and a threaded post hole. A first hip pad button, attached to the hip pad at the first hip pad hole. A second hip pad button, attached to the hip pad at the second hip pad hole.

In some embodiments, a first front cord is connected to the first front button and the first hip pad button. A second front cord is connected to the second front button and the second hip pad button. A rear cord is connected to the first rear button and the second rear button. The headphone clip assembly is attached to the first front cord.

In some embodiments, a hub is attached to threaded cap post. The threaded cap post is inserted through the threaded post hole and held in place with a threaded retaining nut. A continuous grip arm slot is arranged within the hub.

In some embodiments, a first grip arm is fit into the grip arm slot. The first grip arm has a first grip arm upper retaining post, a first grip arm lower retaining post and a first arm. A second grip arm is fit into the grip arm slot. The second grip arm further comprising a second grip arm upper retaining post, a second grip arm lower retaining post and a second arm. A first spring joins the first grip arm upper retaining post to the second grip arm upper retaining post inside the grip arm slot. A second spring joins the first grip arm lower retaining post to the second grip arm lower retaining post inside the grip arm slot. The media device fits between the first grip arm and the second grip arm.

### BRIEF DESCRIPTION OF THE FIGURES

The detailed description of some embodiments of the invention is made below with reference to the accompanying figures, wherein like numerals represent corresponding parts of the figures.

FIG. 1 shows a perspective view of one embodiment of the present invention;

FIG. 2 shows a perspective view of one embodiment of the present invention;

FIG. 3 shows a reverse exploded view of one embodiment of the shoulder harness;

FIG. 4 shows a reverse exploded view of one embodiment of the hip harness;

FIG. 5 shows a detailed perspective view of one embodiment of the headphone clip;

FIG. 6 shows a section view of one embodiment of the present invention taken along line 6-6 in FIG. 2;

FIG. 7 shows a detailed perspective view of one embodiment of the cord onto the button;

FIG. 8 shows a detailed perspective view of one embodiment of the cord onto the button with the sleeve;

FIG. 9 shows a section view of one embodiment of the present invention taken along line 9-9 in FIG. 2;

FIG. 10 shows a section view of one embodiment of the present invention taken along line 10-10 in FIG. 2;

FIG. 11 shows a section view of one embodiment of the present invention illustrating the loosening of retainer nut 40;

FIG. 12 shows a front view of one embodiment of the present invention;

FIG. 13 shows a perspective view of one embodiment of the present invention;

FIG. 14 shows a perspective view of one embodiment of the present invention; and

FIG. 15 shows an exploded view of one embodiment of the pouch assembly.

### DETAILED DESCRIPTION OF CERTAIN EMBODIMENTS

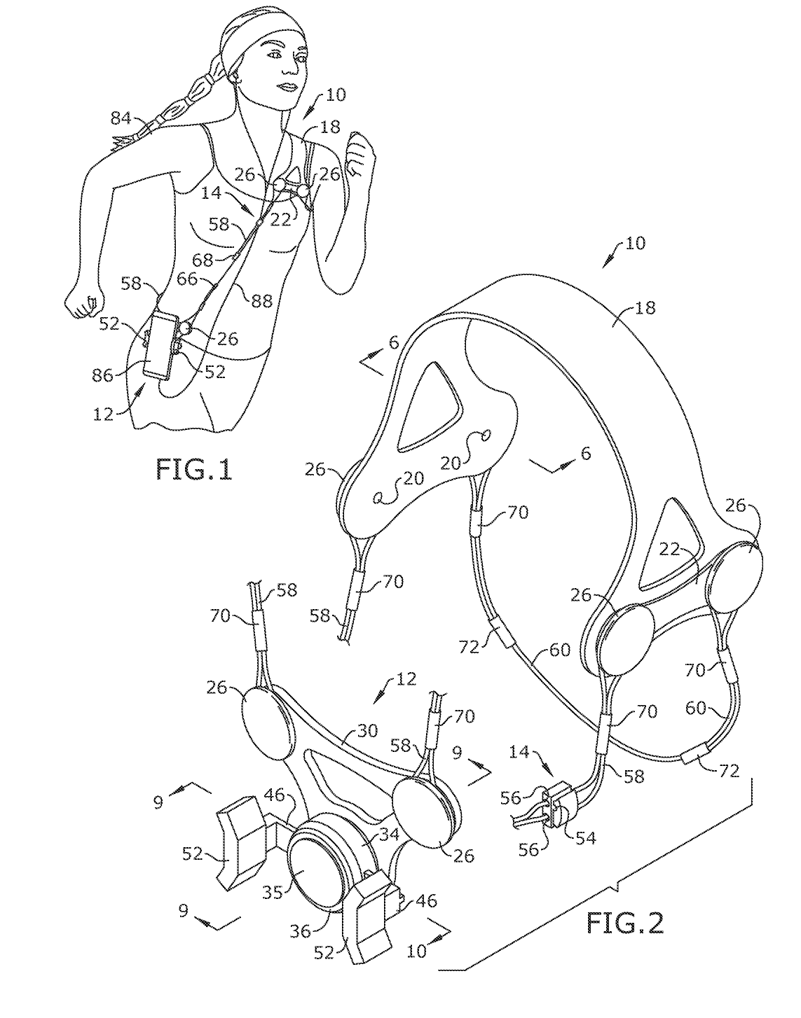

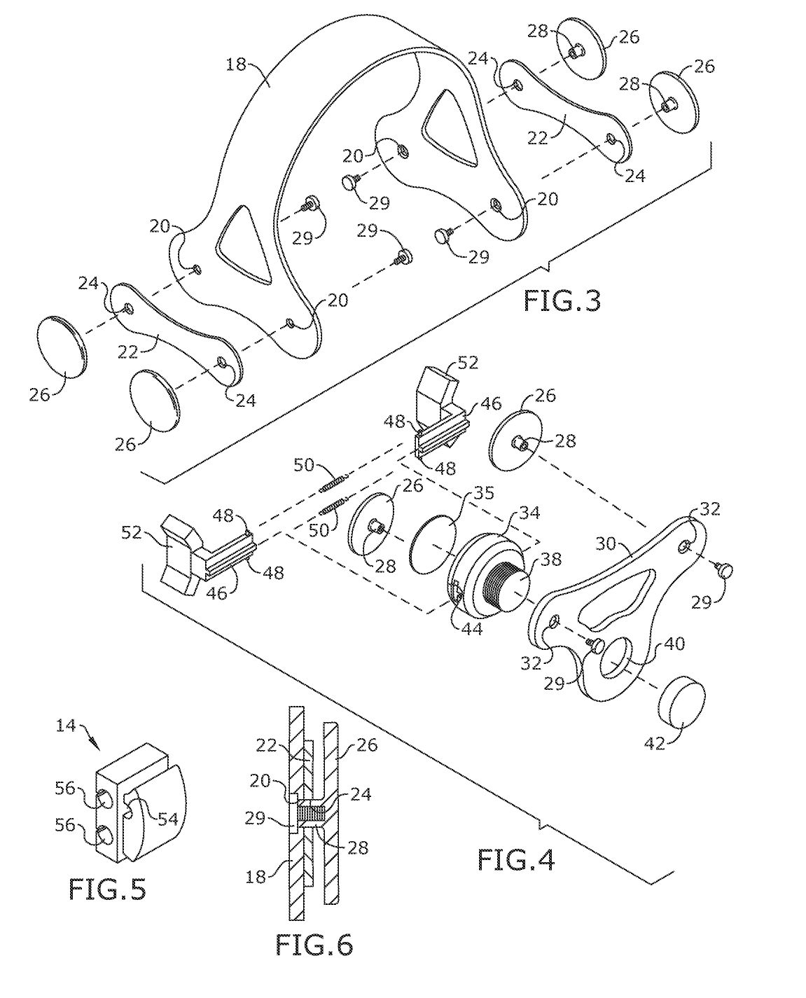

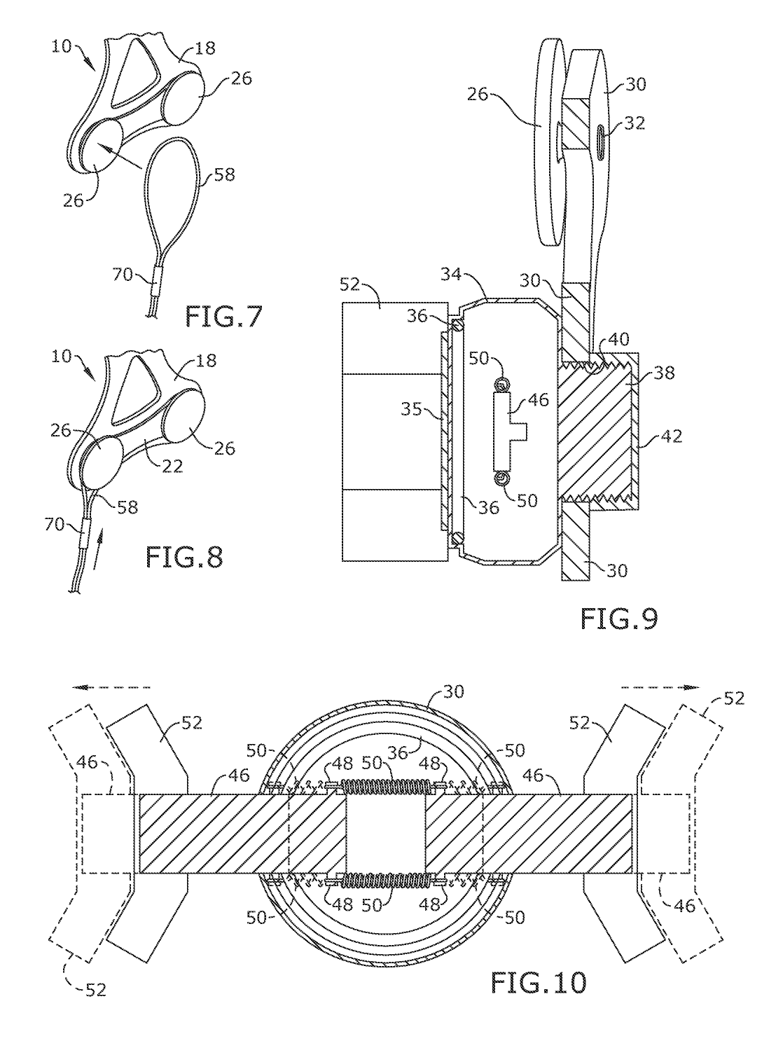

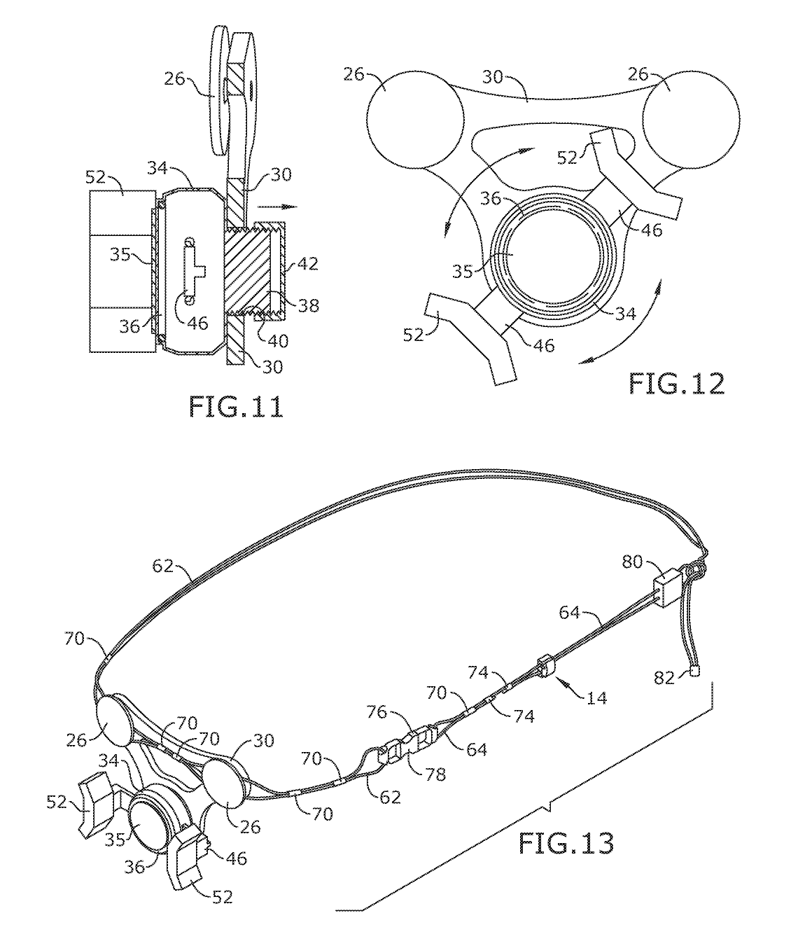

By way of example, and referring to FIG. 1, one embodiment of the media device harness comprises shoulder harness assembly 10 connected to hip harness assembly 12 and headphone clip assembly 14. Shoulder harness assembly 10 further comprises shoulder pad 18. Shoulder pad 18 is perforated with a plurality of shoulder pad holes at a first end and a second end. The first end is further attached to a first connector bar 22, a first front button 26 and a first rear button 28. First front button 26 further comprises first front button post 28 which is adapted to receive first front button screw 29. First rear button 26 further comprises first rear button post 28 which is adapted to receive first rear button screw 29.

Likewise, the second end is further attached to a second connector bar 22, a second front button 26 and a second rear button 28. Second front button 26 further comprises second front button post 28 which is adapted to receive second front button screw 29. Second rear button 26 further comprises second rear button post 28 which is adapted to receive second rear button screw 29.

Turning to FIG. 4, hip harness assembly 12 further comprises hip pad 30. Hip pad 30 further comprises first hip pad hole 32, second hip pad hole 32, and threaded post hole 40. First hip pad hole 32 is configured to accommodate first hip pad button 26 which further comprises first hip pad button post 28 with first hip pad screw 29. Second hip pad hole 32 is configured to accommodate second hip pad button 26 which further comprises second hip pad button post 28 with second hip pad screw 29.

Hub 34 can be attached to bumper 35 and, in some embodiments, decorative ring 36. Hub 36 is further attached to threaded cap post 38 which is adapted to be threaded through threaded post hole 40 and held in place with threaded retaining nut 42. Hub 34 further comprises a continuous grip arm slot 44.

First grip arm 46 is adapted to fit into grip arm slot 44. First grip arm 46 is attached to first grip arm upper retaining post 48, first grip arm lower retaining post 48 and first arm 52. Similarly, second grip arm 46 is adapted to fit into grip arm slot 44. Second grip arm 46 is attached to second grip arm upper retaining post 48, second grip arm lower retaining post 48 and second arm 52. Inside grip arm slot 44, first grip arm upper retaining post 48 is joined to second grip arm upper retaining post 48 with first spring 50. Similarly, first grip arm lower retaining post 48 is joined to second grip arm lower retaining post 48 with first spring 50. As shown in FIG. 10, this permits first arm 52 from being displaced distant second arm 52 to hold the media device there between.

Turning to FIG. 5, headphone clip assembly 14 further comprises headphone grip slot 54, formed by a continuous channel in headphone clip assembly 14. Headphone clip assembly 14 further comprises upper slotted channel 56 and lower slotted channel 56, which are adapted to receive cords or wires.

First front cord 58 is a loop that has a first front cord first end and a first front cord second end. The first front cord first end is partially covered by first front cord first end sleeve 70 and first front cord second end sleeve 70. First front cord first end sleeve 70 compresses the first front cord first end around first front button 26. Likewise, first front cord second end sleeve 70 compresses the first front cord second end around first hip pad button 26.

Second front cord 58 is a loop that has a second front cord first end and a second front cord second end. The second front cord first end is partially covered by second front cord first end sleeve 70 and second front cord second end sleeve 70. Second front cord first end sleeve 70 compresses the second front cord first end around second front button 26. Likewise, second front cord second end sleeve 70 compresses the second front cord second end around second hip pad button 26.

Rear cord 60 is a loop that has a rear cord first end and a rear cord second end. The rear cord first end is partially covered by rear cord first end sleeve 70 and rear cord second end sleeve 70. Rear cord first end sleeve 70 compresses the rear cord first end around first rear button 26. Likewise, rear cord second end sleeve 70 compresses the rear cord second end around second rear button 26.

In some embodiments, rear cord 60 can be a line with fused ends. A first rear cord end can be fused to rear cord 60 with first rear cord stop 72. A second rear cord end can be fused to rear cord 60 with second rear cord stop 72.

In some embodiments, first front cord 58 can be a line with fixed and adjustable ends to tighten the cord to accommodate users with different preferences. This can be done by fusing a distal end to first front cord 58 with fixed cord end stop 66. Likewise a cord can be tightened or loosened with adjustable cord end stop 68.

Turning to FIG. 13, in some embodiments, it may be preferable to use a belt cord assembly. The belt cord assembly comprises long belt cord 62 is wrapped around first hip pad button 26 and held in place with first belt cord sleeve 70. The belt cord assembly can be loosened or tightened with second belt cord sleeve 70 and third belt cord sleeve 70. Long belt cord 62 is wrapped around second hip pad button 26 and held in place with fourth belt cord sleeve 70. Long belt cord 52 is attached to female quick release buckle 78. Female quick release buckle 78 is detachably coupled to male quick release buckle 76.

Male quick release buckle 78 is attached to short belt cord 64. Short belt cord 64 is attached to cord tightening sleeve 70 and each end is fused to short belt cord 64 with belt cord stops 74. Short belt cord 64 is threaded through belt loop retainer block 80 which is then tethered to long belt cord 62 that is fused with long belt end cap 82.

In use, user 84 would like to use media device 86 attached to headphone cords 88. Headphone cords 88 can be threaded through upper slotted channel 56 and lower slotted channel 56. Media device 86 can be inserted between first arm 52 and second arm 52.

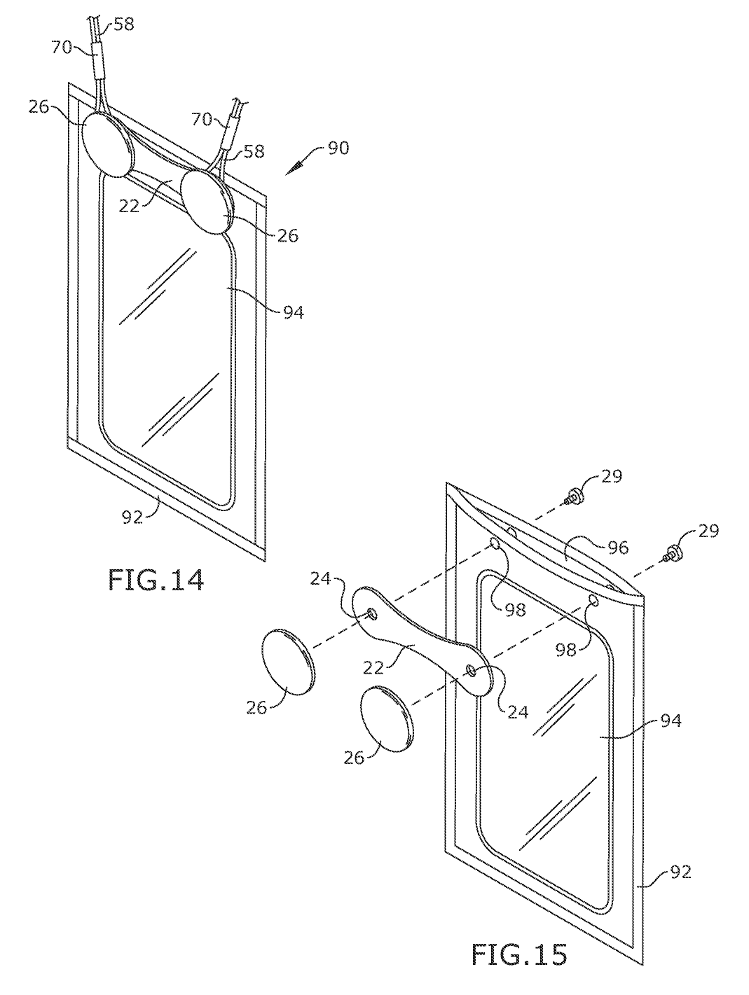

Turning to FIG. 14 and FIG. 15, pouch assembly 90 further comprises pouch 92 having pouch window 94. Pouch 92 further comprises pouch opening 96, through which media device 86 can be inserted. Pouch 92 is drilled with first pouch hole 98 and second pouch hole 98. Pouch connector bar 22 has a first pouch connector bar hole 24 and a second pouch connector bar hole 24. A user can insert first pouch screw 29 through first pouch hole 98, first pouch connector bar hole 24 and into first pouch button 26. Similarly, a user can insert second pouch screw 29 through second pouch hole 98, second pouch connector bar hole 24 and into second pouch button 26.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. §112, ¶6. In particular, any use of “step of” in the claims is not intended to invoke the provision of 35 U.S.C. §112, ¶6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A media device harness, configured to support a media device while a user is engaged in exercise; the media device harness comprising:
a shoulder harness assembly; configured to fit around at least one shoulder of a human user;
a hip harness assembly, connected to the shoulder harness assembly and configured to hold the media device; and
a headphone clip assembly, configured to hold head phone wires of media device.

2. The media device harness of claim 1, wherein the shoulder harness assembly further comprises:
a shoulder pad, perforated with a plurality of shoulder pad holes at a first end and a second end;
wherein the first end is further attached to a first connector bar, a first front button and a first rear button; and
wherein the second end is further attached to a second connector bar, a second front button and a second rear button.

3. The media device harness of claim 2, wherein the hip harness assembly further comprises:
a hip pad further comprising a first hip pad hole, a second hip pad hole, and a threaded post hole;
a first hip pad button, attached to the hip pad at the first hip pad hole; and
a second hip pad button, attached to the hip pad at the second hip pad hole.

4. The media device harness of claim 3, further comprising:
a first front cord connected to the first front button and the first hip pad button;
a second front cord connected to the second front button and the second hip pad button; and
a rear cord, connected to the first rear button and the second rear button;
wherein the headphone clip assembly is attached to the first front cord.

5. The media device harness of claim 3, further comprising:
a hub attached to threaded cap post, wherein the threaded cap post is inserted through the threaded post hole and held in place a with threaded retaining nut; and
a continuous grip arm slot, arranged within the hub.

6. The media device harness of claim 5, further comprising:
a first grip arm, fit into the grip arm slot; the first grip arm further comprising a first grip arm upper retaining post, a first grip arm lower retaining post and a first arm;
a second grip arm, fit into the grip arm slot; the second grip arm further comprising a second grip arm upper retaining post, a second grip arm lower retaining post and a second arm;
a first spring, joining the first grip arm upper retaining post to the second grip arm upper retaining post inside the grip arm slot; and
a second spring, joining the first grip arm lower retaining post to the second grip arm lower retaining post inside the grip arm slot;
wherein the media device fits between the first grip arm and the second grip arm.
